(19) United States
(12) Patent Application Publication
(10) Pub. No.: US 2025/0168065 A1
(43) Pub. Date: May 22, 2025

(54) FAILURE DETECTION AND RECOVERY METHOD AND DEVICE

(71) Applicant: FUJITSU LIMITED, Kawasaki-shi (JP)

(72) Inventors: Meiyi JIA, Beijing (CN); Yang LU, Beijing (CN); Lei ZHANG, Beijing (CN)

(73) Assignee: FUJITSU LIMITED, Kawasaki-shi (JP)

(21) Appl. No.: 19/027,919

(22) Filed: Jan. 17, 2025

Related U.S. Application Data
(63) Continuation of application No. PCT/CN2022/122936, filed on Sep. 29, 2022.

(51) Int. Cl. H04L 41/0816; H04L 43/0823

(52) U.S. Cl. CPC H04L 41/0816; H04L 43/0847

(57) ABSTRACT

A failure detection and recovery device includes: a receiver configured to receive a layer 2 signaling for triggering cell switch; and processor circuitry configured for: performing failure detection after the receiver receives the layer 2 signaling, and applying stored configuration when a handover failure is detected, the stored configuration at least comprising configuration of a cell or cell group in a radio resource control reconfiguration message received and stored by the terminal equipment.

### CROSS-REFERENCE TO RELATED APPLICATION

This application is a continuation application of International Application PCT/CN2022/122936 filed on Sep. 29, 2022, and designated the U.S., the entire contents of which are incorporated herein by reference.

### TECHNICAL FIELD

Embodiments of the present disclosure relate to the technical field of communications.

### BACKGROUND

Network-controlled mobility is applicable to terminals in a connected state, and may be divided into two types of mobility, i.e., cell-level mobility and beam-level mobility.

Cell-level mobility requires explicit radio resource control (RRC) signalling to be triggered, i.e., handover is triggered via the RRC signalling.

The handover mechanism triggered by RRC requires a user equipment (UE) to at least reset a media access control (MAC) entity and reestablish radio link control (RLC), and RRC managed handover with and without a packet data convergence protocol (PDCP) entity reestablishment are both supported.

For data radio bearers (DRBs) using an RLC acknowledged mode (AM), the PDCP may be reestablished together with a security key change or initiate a data recovery procedure “without a key change”. For DRBs using an RLC unacknowledged mode (UM), the PDCP may be reestablished together with a security key change, or remain as it is “without a key change”. For signalling radio bearers (SRBs), the PDCP may remain as it is, discard its stored PDCP packet data units (PDUs)/service data units (SDUs) “without a key change”, or be reestablished together with the security key change.

On the other hand, when a terminal moves from a coverage area of one cell to a coverage area of another cell, a serving cell change needs to be performed at a point. Currently, the serving cell change is triggered by layer 3 (L3) measurement and completed by RRC signaling, a triggered reconfiguration with synchronisation is changed for a primary cell (PCell) and a primary secondary cell (PSCell), and addition/release for secondary cells (SCells) when applicable. All situations involve complete reset of layer 2 (L2) (and layer 1 (L1)), resulting in longer delay, greater overhead and longer interruption duration than beam switch mobility. Objective of L1/L2 mobility enhancement is to ensure a serving cell change via L1/L2 signalling, so as to reduce delay, overhead and interruption duration.

In order to reduce a mobility delay, a mechanism and procedure of L1/L2 based inter-cell mobility include the following:
configuration and maintenance of multiple candidate cells to allow fast application of configuration for candidate cells;
for possible applicable scenarios, a dynamic handover mechanism between L1/L2 based candidate serving cells (including special cells and secondary cells;
L1 enhancement of inter-cell beam management, including L1 measurement and reporting, and beam indication;
timing advance management; and
centralized unit-distributed unit (CU-DU) interface signalling to support L1/L2 mobility.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

The inventor finds that in the process of L1/L2 based inter-cell mobility, some compositions use existing mechanisms to complete new tasks, such as using existing RRC reconfiguration processes to complete new candidate configuration; some compositions are new processes, such as a processing process of a cell switch command. For these two situations, currently how to determine if this process fails thus to take recovery measures is unknown. On the other hand, currently handover failure/radio link failure/reconfiguration failure will initiate an RRC connection reestablishment process. If this process is reused, large service interruption will be introduced.

For at least one of the above problems or other similar problems, the embodiments of the present disclosure provide a failure detection and recovery method and device, which can detect possible failures faster and recover from failures faster, thereby reducing service interruption time and improving user experience.

According to an aspect of the embodiments of the present disclosure, a failure detection and recovery device is provided, the device including:
a detecting unit configured to perform failure detection; and
a processing unit configured to, when the detecting unit detects one of a link failure, a measurement reporting failure, a cell switch command reception failure, a terminal equipment processing failure and a handover failure, apply stored configuration for recovery and/or report the failure to a network device via a secondary cell and/or a non-serving cell.

One of advantageous effects of the embodiments of the present disclosure lies in: according to the embodiments of the present disclosure, when one of a link failure, a measurement reporting failure, a cell switch command reception failure, a terminal equipment processing failure and a handover failure is detected, a terminal applies stored configuration and/or reports the failure via a secondary cell/a non-serving cell, thereby failure detection and recovery may be performed faster, thus reducing service interruption time and improving user experience.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of and terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of mobility delay of L1/L2 based inter-cell mobility;

FIG. 2 is a schematic diagram of a deployment scenario of a NG-RAN in the embodiments of the present disclosure;

FIG. 3 is a schematic diagram of a deployment scenario of an IAB in the embodiments of the present disclosure;

FIG. 4 is a schematic diagram of a failure detection and recovery method in the embodiments of the present disclosure;

FIG. 5 is another schematic diagram of a failure detection and recovery method in the embodiments of the present disclosure;

FIG. 6 is a further schematic diagram of a failure detection and recovery method in the embodiments of the present disclosure;

FIG. 7 is another schematic diagram of a failure detection and recovery method in the embodiments of the present disclosure;

FIG. 8 is a further schematic diagram of a failure detection and recovery method in the embodiments of the present disclosure;

FIG. 9 is a further schematic diagram of a failure detection and recovery method in the embodiments of the present disclosure;

FIG. 10 is a schematic diagram of a failure detection and recovery device in the embodiments of the present disclosure;

FIG. 11 is another schematic diagram of a failure detection and recovery device in the embodiments of the present disclosure;

FIG. 12 is a schematic diagram of a terminal equipment in the embodiments of the present disclosure;

FIG. 13 is a schematic diagram of a network device in the embodiments of the present disclosure.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms.

The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system can be carried out according to a communication protocol at any stage, for example may include but be not limited to the following communication protocols: 1G (generation), 2G, 2.5G, 2.75G, 3G, 4G, 4.5G, 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: node B (NodeB or NB), evolution node B (eNodeB or eNB) and a 5G base station (gNB), etc., and may further includes Remote Radio Head (RRH), Remote Radio Unit (RRU), a relay or a low power node (such as femeto, pico, etc.), an Integrated Access and Backhaul (IAB) node or an IAB-DU or IAB-donor. And the term “base station” may include some or all functions of a base station, each base station may provide communication coverage to a specific geographic region. The term “cell” may refer to a base station and/or its coverage area, which depends on the context in which this term is used. In a case where there is no confusion, the terms “cell” and “base station” are interchangeable.

In the embodiments of the present disclosure, the term “User Equipment (UE)” or “Terminal Equipment (TE) or Terminal Device” refers to, for example, a device that accesses a communication network and receives network services through a network device. The terminal equipment can be fixed or mobile, and can also be referred to as Mobile Station (MS), a terminal, Subscriber Station (SS), Access Terminal (AT), IAB-MT (Mobile Terminal), a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipments as described above. If it is not specifically mentioned herein, “a device” may refer to a network device, or may refer to a terminal equipment.

Currently, for detection and recovery of a handover failure (HOF), a timer based handover failure procedure is supported in NR. RRC connection reestablishment procedure is used for recovery from a handover failure, except in certain conditional handover (CHO) or dual active protocol stack (DAPS) handover scenarios:
when DAPS handover fails, if a source link has not been released yet, a UE falls back to source cell configuration, resumes connection with a source cell, and reports the DAPS handover failure via a source without triggering RRC connection reestablishment;
when an initial CHO execution attempt fails or a HO fails, the UE performs cell selection, and if the selected cell is a CHO candidate and if a network configured UE to try CHO after handover/CHO failure, then the UE attempts CHO execution once, otherwise reestablishment is performed.

In addition, for detection and recovery of a radio link failure, the UE declares a radio link failure (RLF) when one of the following conditions is met:
Expiry of a radio problem timer started after indication of radio problems from a physical layer (if a radio problem is recovered before the timer expires, the UE stops the timer); or
Expiry of a timer started upon triggering a measurement report for a measurement ID for which the timer has been configured while another radio problem timer is running; or
a random access procedure failure; or
an RLC failure; or
detection of consistent uplink LBT (listen before talk) failure for operation with shared spectrum channel access; or
for an IAB-MT, reception of a BH RLF (backhaul radio link failure) indication received from its parent node.

In the case of the DAPS handover, the UE continues detection of radio link failures in the source cell until a random access procedure to a target cell is completed successfully.

After the RLF is declared, the UE will:
stay in RRC_CONNECTED;
in the case of the DAPS handover, for RLF in the source cell:
   stop any data transmission or reception via a source link and release the source link, but maintain source RRC configuration;
   if a handover failure is then declared at the target cell, the UE will:
      select a suitable cell, and then initiate RRC reestablishment;
      if a suitable cell was not found within a certain time after the handover failure was declared, enter RRC_IDLE;
   in the case of the CHO, for RLF in the source cell:
      select a suitable cell and if the selected cell is a CHO candidate and if a network configured UE try CHO after RLF, the UE attempts CHO execution once, otherwise reestablishment is performed;
      if a suitable cell was not found within a certain time after the RLF was declared, enter RRC_IDLE;
   otherwise, for RLF in a serving cell or in case of DAPS handover, for RLF in the target cell before releasing the source cell:
      select a suitable cell, and then initiate RRC reestablishment;
      if a suitable cell was not found within a certain time after RLF was declared, enter RRC_IDLE.

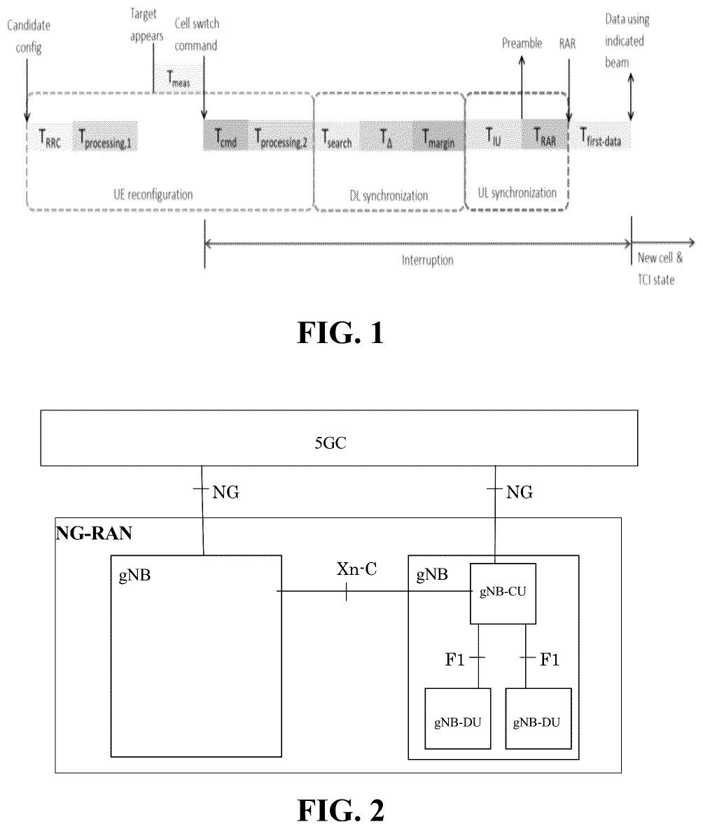

The inventor finds that currently, the mobility delay of L1/L2 based inter-cell mobility includes components shown in FIG. 1, and the meanings of the components are shown in Table 1.

TABLE 1

| Component | Meanings | Value |
|---|---|---|
| T_{RRC} | Processing time of RRCReconfiguration | Up to 10 milliseconds |
| | carrying candidate configuration | |
| T_{processing, 1}/ | UE processing time, before or after a cell | For the same FR (frequency |
| T_{processing, 2} | switch command respectively, may include | range), up to 20 milliseconds |
| | L2/3 reconfiguration, RF retuning, | For different FRs, Up to 40 |
| | baseband retuning, security update (if | milliseconds |
| | necessary), etc | |
| Tₘₑₐₛ | Measurement delay (from target | — |
| | appearance to a cell switch command) | |
| T_{cmd} | Time to process L1/L2 signaling (HARQ | Up to 5 milliseconds |
| | (Hybrid Automatic Repeat reQuest) and | |
| | parsing) | |
| T_{search} | Time required for searching a target cell | 0 milliseconds (if a cell is known) |
| | | Up to 60 milliseconds (if a cell is |
| | | unknown) |
| T_{Δ} | Time for fine tracking and obtaining full | SMTC (SSB Measurement Timing |
| | timing information | Configuration) period (typically |
| | | 20 milliseconds) |
| T_{margin} | SSB (Synchronization Signal Block) or | Up to 2 milliseconds |
| | CSI-RS (Channel State Information- | |
| | Reference Signal) post-processing time | |
| T_{IU} | Acquiring interrupt uncertainty in a first | Typically 15 milliseconds |
| | available Physical Random Access | |
| | Channel (PRACH) occasion in a new cell | |
| T_{RAR} | RAR (Random Access Response) delay | Typically 4 milliseconds |
| | time | |
| T_{first-data} | After RAR, time for a UE to execute a first | — |
| | DL/UL reception/transmission on a beam | |
| | indicated by a target cell | |

The above time values are just examples.

As described above, for failure detection, in the L1/L2 based inter-cell mobility process, some constituent components are new tasks completed using existing mechanisms, some constituent components are new processes, while how to determine a failure of the process thereby to take recovery measures is unknown. On the other hand, for failure recovery, a current failure will initiate the RRC connection re-establish process, which, if the process is reused, major service interruption will be introduced.

For at least one of the above problems, the present disclosure is proposed, and the embodiments of the present disclosure are described in combination with the drawings and the specific implementations.

In the embodiments of the present disclosure, failure detection and recovery scenarios include but are not limited to a handover scenario, a carrier aggregation (CA) scenario, and a dual connectivity (DC) scenario. The handover scenario is mobility of only a PCell. The CA scenario includes: a scenario in which target PCells/target SCell(s) are not current serving cells, i.e., a CA→CA scenario in which a PCell is changed; a scenario in which the target PCell is a current SCell; and a scenario in which the target SCell is a current PCell. In addition, the DC scenario is for example a scenario in which the PSCell is changed (including a non-CA scenario and a CA scenario).

In the embodiments of the present disclosure, the source cell and the target cell may be synchronous or asynchronous, may be of the same frequency or different frequency, and may operate on FR1 (frequency range 1) and FR2 (frequency range 2).

FIG. 2 is a schematic diagram of a deployment scenario of a NG-RAN in the embodiments of the present disclosure. As shown in FIG. 2, the NG-RAN includes a group of gNBs connected to 5GC via a NG interface. The gNBs may be interconnected via an Xn interface. One gNB may include one gNB-CU and one or more gNB-DU(s), one gNB-CU and one gNB-DU are connected via an F1 interface, and one gNB-DU may only be connected to one gNB-CU.

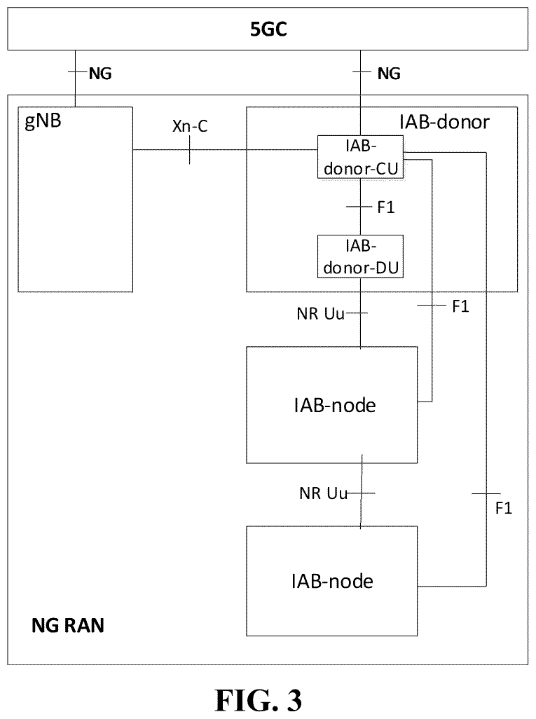

FIG. 3 is a schematic diagram of a deployment scenario of an IAB in the embodiments of the present disclosure. As shown in FIG. 3, the NG-RAN is wirelessly connected to a gNB capable of serving IAB-nodes via IAB-nodes, called an IAB-donor to support an IAB. The IAB-donor includes one IAB-donor-CU and one or more IAB-donor-DU(s).

In the embodiments of the present disclosure, all functions defined for a gNB-DU also apply to IAB-DUs and IAB-donor-DUs, all functions defined for a gNB-CU also apply to IAB-donor-CUs, and all functions defined for a UE also apply to IAB-MTs, unless otherwise specified.

In the following description, without causing confusion, “failure” may be replaced with “that needs to be recovered”, “if . . . ” may be replaced with “in a case where . . . ” or “when . . . ”, “it is considered that a failure occurs . . . ” and “it is determined that a failure is detected . . . ” may be interchangeable, “determine whether a failure occurs . . . ” and “determine whether a failure is detected . . . ” may be interchangeable. In addition, in the following description, the lower layer refers to a physical layer, a radio frequency (RF) link, etc., and the higher layer refers to an RRC layer, a MAC layer, etc.

### Embodiments of a First Aspect

The embodiments of the present disclosure provide a failure detection and recovery method, which will be described from a terminal equipment side.

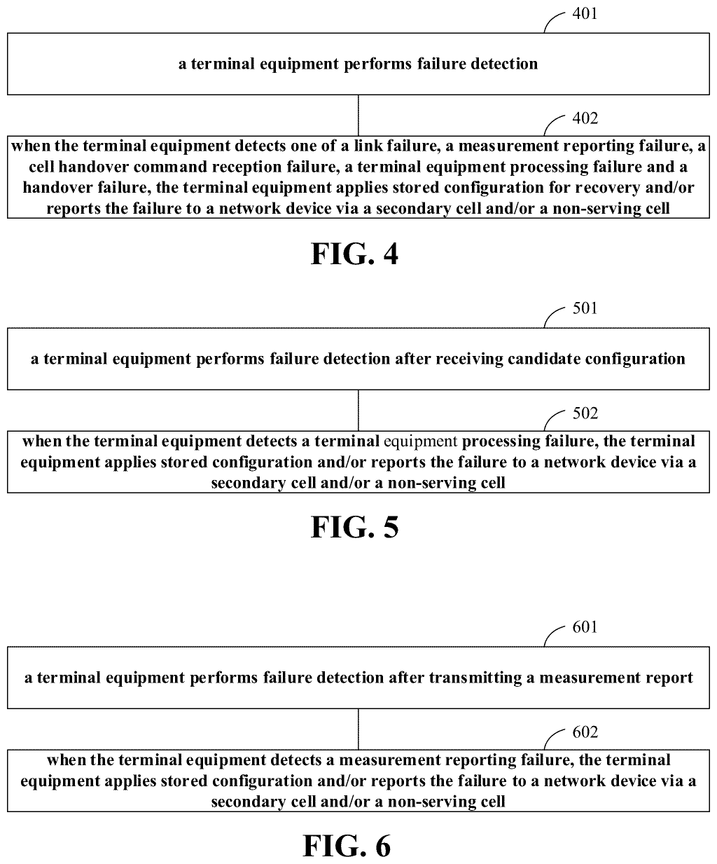

FIG. 4 is a schematic diagram of a failure detection and recovery method in the embodiments of the present disclosure. As shown in FIG. 4, the method includes:
401, a terminal equipment performs failure detection; and
402, when the terminal equipment detects one of a link failure, a measurement reporting failure, a cell switch command reception failure, a terminal equipment processing failure and a handover failure, the terminal equipment applies stored configuration for recovery and/or reports the failure to a network device via a secondary cell and/or a non-serving cell.

It should be noted that the above FIG. 4 only schematically describes the embodiments of the present disclosure, but the present disclosure is not limited to this. For example, other some operations can be increased or operations therein may be reduced. Persons skilled in the art may make appropriate modifications according to the above contents, not limited to the records in the above FIG. 4.

In the above embodiments, when one of a link failure, a measurement reporting failure, a cell switch command reception failure, a terminal equipment processing failure and a handover failure is detected, a terminal applies stored configuration and/or reports the failure via a secondary cell/a non-serving cell, thereby failure detection and recovery may be performed faster, thus reducing service interruption time and improving user experience.

In some embodiments, when the terminal equipment detects one of a link failure, a measurement reporting failure, a cell switch command reception failure, a terminal equipment processing failure and a handover failure, the terminal equipment applies stored configuration for recovery; and if the stored configuration cannot be applied for recovery, reports the failure to a network device via a secondary cell and/or a non-serving cell. That is, when a failure is detected, the stored configuration is first applied for recovery, and if the stored configuration cannot be applied for recovery, for example, there is no stored configuration, or the stored configuration cannot be applied for recovery successfully, the failure is then reported to a network device via a secondary cell and/or a non-serving cell. Thereby, the delay of recovery is reduced and the signaling cost for recovery is saved.

In the above embodiments, the stored configuration refers to configuration of a cell or cell group in an RRC reconfiguration message received and stored by the terminal equipment, such as configuration of a cell or cell group in an RRC reconfiguration message received by the terminal equipment before the failure is detected, the terminal equipment may store the configuration locally, and when the failure is detected, the terminal equipment first attempts to apply the configuration for recovery.

In the above embodiments, the configuration of the cell or cell group includes configuration of a primary cell and/or configuration of a secondary cell.

For example, when the failure is detected or triggered, during cell selection or reselection, a terminal finds a suitable cell which is a primary cell included in the previously received RRC reconfiguration message, the terminal applies the stored configuration of this cell. Optionally, the terminal may further apply corresponding configuration (if any) of a secondary cell.

For another example, when the failure is detected or triggered, if a condition of a cell or cell group in the previously received RRC reconfiguration message is met, the terminal applies stored configuration of a cell that meets the condition. If the cell that meets the condition is a primary cell, optionally, the terminal may further apply corresponding configuration of a secondary cell.

In the above embodiments, the configuration of a cell or cell group further includes beam information, the beam information e.g. being transmission configuration indication (TCI) state information of a downlink channel or an uplink channel or a reference signal.

In some embodiments, if there are more than N of the TCI state information, the terminal equipment may apply M pieces of the TCI state information indicated or default or determined through evaluation, in more than N pieces of the TCI state information, where M≤N, and N is 1 or 2, depending on a capability of the terminal equipment.

For example, if the M pieces of the TCI state information are indicated or default, M=N, that is, the terminal equipment applies indicated or default M pieces of the TCI state information. If the M pieces of the TCI state information are determined through evaluation, M≤N, that is, the terminal equipment determines to apply M pieces of the TCI state information that meet conditions, through evaluation.

For example, according to a capability of a terminal equipment 1, if the number of pieces of the TCI state information is more than 2, the terminal equipment 1 may apply at most first two pieces of appeared TCI state information, or apply at most two pieces of TCI state information corresponding to beams which meet candidate beam conditions. For another example, according to a capability of a terminal equipment 2, if the number of pieces of the TCI state information is more than 1, the terminal equipment 2 may apply the first piece of appeared TCI state information, or apply one piece of TCI state information corresponding to beams which meet candidate beam conditions.

In some other embodiments, that report the failure to a network device via a secondary cell and/or a non-serving cell includes: reporting the failure to a network device via a secondary cell; if the secondary cell is unavailable, reporting the failure to the network device via a non-serving cell. Or, in some other embodiments, that report the failure to a network device via a secondary cell and/or a non-serving cell includes: reporting the failure to a network device via a non-serving cell; if the non-serving cell is unavailable, reporting the failure to the network device via a secondary cell, for example the non-serving cell is associated with a special cell.

For example, when a failure is detected, the stored configuration is first applied for recovery, and if the stored configuration cannot be applied for recovery, for example, there is no stored configuration, or the stored configuration cannot be applied for recovery successfully, the failure is reported to a network device via a secondary cell, and if the secondary cell is unavailable, the failure is reported to the network device via a non-serving cell.

For another example, when a failure is detected, the failure is first reported to a network device via a secondary cell; if the secondary cell is unavailable, the failure is reported to the network device via a non-serving cell; if there is no non-serving cell or the non-serving cell is unavailable, stored configuration is then applied for recovery.

The above two examples are just illustrative, the present disclosure is not limited to these.

In the above embodiments, the non-serving cell is a candidate cell for handover, such as a candidate primary cell or candidate secondary cell; or is a cell associated with a current serving cell, such as a cell in which the terminal equipment is using its dedicated channel, and so on.

In the above embodiments, the terminal equipment may report the following contents to the network device via a secondary cell and/or a non-serving cell:
cell information of a failed cell;
a failure cause and/or a failure type;
a measurement result; and
expected processing.

That is, the terminal equipment reports the failure by reporting at least one of the above contents.

In the above example, the cell information of the failed cell may include a cell index and/or a cell ID, such as a physical cell identifier (PCI) and an NR cell global identifier (NCGI). The cell index may be a serving cell index; or, may be an order in which a cell or a cell group which the cell belongs to appears in configuration of the cell or cell group in an RRC reconfiguration message. For example, the configuration of a cell or cell group that appears firstly with a corresponding index being 0 (or 1), the configuration of a cell or cell group that appears secondly with a corresponding index being 1 (or 2), and so on.

In the above example, the failure cause may be that: a corresponding timer expires, the number of received NACK (negative acknowledgements, that is negative feedbacks) reaches a maximum value, and the number of random access preamble (RAP) transmissions reach a maximum number, etc. The failure type may be: a link failure, a measurement reporting failure, a cell switch command reception failure, a terminal equipment processing failure, and a handover failure, etc.

In the above example, the measurement result may include a L1 measurement or L3 measurement based measurement result of a beam and/or a cell for a failed cell and/or a candidate cell that meets a condition. For example, the terminal equipment reports a beam measurement result based on L1 measurement for a failed cell. For another example, the terminal equipment reports a beam measurement result based on L1 measurement for a candidate cell that meets conditions, and so on.

In the above example, the expected processing may be a beam switch or a cell switch, the present disclosure is not limited to this.

For example, if the expected processing is a beam switch, the terminal equipment may indicate a beam that is expected to be used or an available beam, such as an identifier of a reference signal, such as an SSB index, a CSI-RS ID or an SRS ID. Optionally, the terminal equipment further indicates a measurement result of the beam, such as L1 SS-RSRP, L1 SS-SINR, L1 CSI-RSRP, L1 CSI-SINR.

For another example, if the expected processing is a cell switch, the terminal equipment may indicate a cell that is expected to be used or an available cell, such as a cell identifier or index; the cell identifier may be a PCI or a NCGI. Optionally, the terminal equipment further indicates a measurement result of the cell or a measurement result of reference signal for a cell, such as RSRP, RSRQ, SINR, or SS-RSRP, SS-SINR, CSI-RSRP, CSI-SINR.

In the embodiments of the present disclosure, the terminal equipment may report the above failure via an RRC message or via a MAC control element (MAC CE), the present disclosure is not limited to this. For example, according to a reported content, the terminal equipment may report the above failure via both the RRC message and the MAC CE.

For example, the terminal equipment reports the above failure via an RRC message. If the terminal equipment is configured with dual connectivity (such as NR-DC), and if SRB1 is configured as a split SRB and pdcp-Duplication is not configured, the terminal equipment sets primaryPath of a PDCP entity of the SRB1 refer to SCG (Secondary Cell Group), the RRC message is transmitted via the SRB1; otherwise, if SRB3 is configured and if SCG transmission is not suspended or allowed, the RRC message (embedded in another RRC message, such as ULInformation TransferMRDC message) is transmitted via the SRB3. The RRC message may be a FailureInformation message, or a MCGFailureInformation message, or a new RRC message.

For another example, the terminal equipment reports the above failure via a MAC CE. When there is an available uplink shared channel (UL-SCH) resource in a secondary cell or non-serving cell, and as a result of logical channel prioritization (LCP), the resource is sufficient to accommodate a MAC CE for carrying said information, the terminal equipment generates the MAC CE, otherwise, triggers a scheduling request (SR). A network may configure a dedicated physical uplink control channel (PUCCH) resource or a SR ID for this SR or enable this SR to use a PUCCH resource or a SR ID of other SR (such as SR corresponding to a logical channel (LCH), SR corresponding to consistent LBT failure MAC CE, or SR corresponding to a beam failure recovery (BFR) MAC CE). This MAC CE is identified by an MAC subheader where a logical channel identification (LCID) or an enhanced LCID (eLCID) is located.

Each of the above embodiments only exemplarily describes that the terminal equipment reports the above failure to the network device via a secondary cell and/or non-serving cell, but the present disclosure is not limited to this, appropriate modifications may be further made based on the above each embodiment. For example, each of the above embodiments may be used individually, or one or more of the above embodiments may be combined.

In the embodiments of the present disclosure, in some implementations, when the quality of a radio link or the quality of a control channel is not good or poor, the terminal equipment considers that a link failure occurs.

In the above implementation, the quality of the radio link or the quality of the control channel is characterized by the L1 measurement result or a filtered L1 measurement result, and when the L1 measurement result or the filtered L1 measurement result is worse than a configured threshold, it is considered that “the quality is not good or poor”. Similarly, when the L1 measurement result or the filtered L1 measurement result is better than the configured threshold, it is considered that “the quality is good”. In the embodiments of the present disclosure, a value of the threshold is not limited. For example, it may be set according to a network deployment situation.

In some embodiments, that the terminal equipment performs failure detection includes: a physical layer of the terminal equipment measures a configured reference signal, and provides indications of poor quality and/or good quality to a higher layer, the higher layer determines whether a link failure occurs according to received indications and/or a timer.

In the above embodiment, the reference signal may be a reference signal configured for beam failure detection (BFD-RS), or a reference signal configured for radio link listening (RLM-RS), or a reference signal configured for fast or lower-layer radio link failure detection, but the present disclosure is not limited to this.

In the above embodiment, the reference signal may be configured per serving cell, that is, each serving cell is configured with one reference signal or a group of reference signals.

In the above embodiment, “the quality is poor and/or good” may be: the L1 measurement result is worse and/or is better than a configured threshold (or its equivalent value, called a first threshold) by an offset or a period of time, or refers to that the filtered L1 measurement result is worse and/or is better than a configured threshold (or its equivalent value, called a second threshold) by an offset or a period of time. Here, the L1 measurement result may be L1 RSRP, including SS-RSRP or CSI-RSRP; may further be L1 RSRQ, including SS-RSRQ or CSI-RSRQ; may further be L1 SINR, including SS-SINR or CSI-SINR.

In the above embodiments, the filtered L1 measurement result is a measurement result derived after the L1 measurement result is processed (such as an operation), for example, it may be an average value of multiple L1 measurement results within a period of time, or it may be an average value of multiple highest L1 measurement results.

In the above embodiments, the higher layer of the terminal equipment determines whether a link failure occurs, according to received indications (indications of poor quality and/or good quality) and/or a timer. Here, the higher layer may be an MAC layer and/or an RRC layer.

For example, when the higher layer of the terminal equipment receives an indication of poor quality, a first timer is started or restarted. When the first timer expires, the number of indications of poor quality is recounted. When M consecutive indications of poor quality are received, it is considered that a link failure occurs. That is, whether a link failure occurs is determined according to the number of indications of poor quality.

For another example, when the higher layer of the terminal equipment receives M consecutive indications of poor quality, a second timer is started. When the higher layer of the terminal equipment receives T indications of good quality, the second timer is stopped. When the second timer expires, it is considered that a link failure occurs. That is, whether a link failure occurs is determined according to whether a timer expires.

For a further example, when the higher layer of the terminal equipment receives M consecutive indications of poor quality while a third timer is running, it is considered that a link failure occurs. That is, whether a link failure occurs is determined according to indications of poor quality and a timer.

For another example, when the higher layer of the terminal equipment receives M consecutive indications of poor quality, it is considered that a link failure occurs. When the higher layer of the terminal equipment receives T indications of good quality, the number of indications of poor quality is recounted. That is, whether a link failure occurs is determined according to indications of poor quality and indications of good quality.

For a further example, when the higher layer of the terminal equipment receives M consecutive indications of poor quality, it is considered that a link failure occurs. That is, whether a link failure occurs is determined only according to indications of poor quality.

In the above embodiments, a value of each timer is not limited, and may be set as needed.

In some other embodiments, that the terminal equipment performs failure detection includes: the terminal equipment performs monitoring on NACK and/or ACK (acknowledgement, positive feedback) of a HARQ process, and determines whether a link failure occurs according to a monitoring result.

For example, if S consecutive NACK indications are received within a period of time, it is considered that a link failure occurs, and/or, if an ACK indication is not received within a period of time (for example S consecutive ACK indications are not received), it is considered that a link failure occurs.

In the above embodiments, the HARQ process may be a specified HARQ process, or one HARQ process, or all HARQ processes.

In the above embodiments, either a physical layer of the terminal equipment performs monitoring on the NACK and/or ACK of the HARQ process, or an MAC layer of the terminal equipment perform monitoring on the NACK and/or ACK of the HARQ process.

Each of the above embodiments only exemplarily describes how does a terminal equipment determine that a link failure occurs, but the present disclosure is not limited to this, appropriate modifications may be further made based on the above each embodiment. For example, each of the above embodiments may be used individually, or one or more of the above embodiments may be combined.

In the embodiments of the present disclosure, in some other implementations, when L1 or L2 signaling carrying a measurement result is not successfully transmitted to a network device, the terminal equipment considers that a measurement reporting failure occurs.

In some embodiments, that the terminal equipment performs failure detection includes: a fourth timer is started when the terminal equipment generates or delivers to a lower layer or transmits L1 or L2 signaling carrying a measurement result; when the fourth timer expires, it is considered that a measurement reporting failure occurs.

For example, when L1 signaling carrying a measurement result is generated or transmitted, or when L2 signaling carrying a measurement result is generated and delivered to a lower layer, the terminal equipment starts the fourth timer, and when the fourth timer expires, it is considered that a measurement reporting failure occurs.

In the above embodiment, after ACK of the HARQ process (that is, a HARQ process of the L1 or L2 signaling carrying the measurement result) is received, or an UL grant for scheduling new transmission of the HARQ process is received, or a cell switch command is received, it means that measurement reporting has been successful, in such a case, the fourth timer may be stopped.

In the above embodiment, the cell switch command may be carried by downlink control information (DCI), MAC CE, RRC message, etc., the present disclosure is not limited to this.

In some other embodiments, that the terminal equipment performs failure detection includes: the terminal equipment performs monitoring on NACK and/or ACK of a HARQ process of the L1 or L2 signaling carrying the measurement result, and determines whether a measurement reporting failure occurs according to a monitoring result.

For example, if X consecutive NACK indications are received within a period of time, it is considered that a measurement reporting failure occurs, and/or, if an ACK indication is not received within a period of time (for example X consecutive ACK indications are not received), it is considered that a measurement reporting failure occurs.

In the above embodiments, either a physical layer of the terminal equipment performs monitoring on NACK and/or ACK of the HARQ process of the L1 or L2 signaling carrying the measurement result, or an MAC layer of the terminal equipment performs monitoring on the NACK and/or ACK of the HARQ process of the L1 or L2 signaling carrying the measurement result.

In the above embodiments, a value of the fourth timer is not limited, and may be set as needed.

Each of the above embodiments only exemplarily describes how does a terminal equipment determine that a measurement reporting failure occurs, but the present disclosure is not limited to this, appropriate modifications may be further made based on the above each embodiment. For example, each of the above embodiments may be used individually, or one or more of the above embodiments may be combined.

In the embodiments of the present disclosure, in some other implementations, after L1 or L2 signaling carrying a measurement result is transmitted successfully, if no cell switch command is received within a period of time, the terminal equipment considers that a cell switch command reception failure occurs.

In some embodiments, that the terminal equipment performs failure detection includes: the terminal equipment performs monitoring on ACK indications of a HARQ process of the L1 or L2 signaling carrying the measurement result, starts a fifth timer when an ACK indication is received, and considers that a cell switch command reception failure occurs when the fifth timer expires.

That is, for the HARQ process of the L1 or L2 signaling carrying the measurement result, the terminal equipment starts a fifth timer when receiving an ACK indication, and considers that a cell switch command reception failure occurs when the fifth timer expires.

In the above embodiment, the terminal equipment stops the fifth timer upon receiving a cell switch command.

In the above embodiment, the cell switch command may be carried by DCI or MAC CE or RRC message, etc., the present disclosure is not limited to this.

In the above embodiments, a value of the fifth timer is not limited, and may be set as needed.

Each of the above embodiments only exemplarily describes how does a terminal equipment determine that a cell switch command reception failure occurs, but the present disclosure is not limited to this, appropriate modifications may be further made based on the above each embodiment. For example, each of the above embodiments may be used individually, or one or more of the above embodiments may be combined.

In the embodiments of the present disclosure, in some other implementations, when the terminal equipment is unable to comply with an RRC reconfiguration message that carries candidate cell information, or is unable to comply with PCell configuration in the RRC reconfiguration message that carries the candidate cell information, or is unable to comply with PCell indicated by an L1 or L2 cell switch command in the RRC reconfiguration message that carries the candidate cell information, it is considered that a terminal equipment processing failure occurs.

In the above embodiment, terminal processing includes processing on the RRC reconfiguration message that carries the candidate cell information and/or the L1 or L2 cell switch command, however, due to limitations in terminal capabilities, it may not be able to comply with the above RRC reconfiguration message that carries the candidate cell information and/or the L1 or L2 cell switch command, then when it is unable to comply with the above RRC reconfiguration message that carries the candidate cell information and/or the L1 or L2 cell switch command, it is considered that a terminal equipment processing failure occurs.

In the above embodiment, PCell configuration may be configuration of any PCell in the above RRC reconfiguration message that carries the candidate cell information, or may be configuration of a PCell in the above RRC reconfiguration message that carries the candidate cell information, the present disclosure is not limited to this.

In the above embodiments, the PCell configuration includes configuration of L1 or L2 or L3, such as MAC configuration, radio bearer configuration, RF configuration.

Each of the above embodiments only exemplarily describes how does a terminal equipment determine that a terminal equipment processing failure occurs, but the present disclosure is not limited to this, appropriate modifications may be further made based on the above each embodiment. For example, each of the above embodiments may be used individually, or one or more of the above embodiments may be combined.

In the embodiments of the present disclosure, in some other implementations, when a L1 or L2 signaling based cell switch fails, the terminal equipment considers that a handover failure occurs.

In the above embodiments, the terminal equipment determines whether a handover failure occurs based on whether a L1 or L2 signaling based cell switch succeeds or fails.

In some embodiments, the terminal equipment determines whether a handover failure occurs based on a timer (called a sixth timer) for controlling a L1 or L2 signaling based cell switch.

In the above embodiments, that the terminal equipment performs failure detection includes: the terminal equipment starts a sixth timer upon receiving L1 or L2 signaling used to trigger a cell switch, and considers that a handover failure occurs when the sixth timer expires.

In the above embodiments, when the terminal equipment completes a random access procedure, or the terminal equipment begins to communicate with an indicated cell, or the terminal equipment transmits, to a target cell, information for indicating that handover is completed or handover to the target cell is successful, it means that the handover has been completed, at this moment, the terminal equipment stops the sixth timer.

In the above embodiments, a value of the sixth timer is not limited, and may be set as needed.

In some other embodiments, the terminal equipment determines whether a handover failure occurs based on the number of transmissions of an RA preamble.

In the above embodiments, that the terminal equipment performs failure detection includes: the terminal equipment counts the number of transmitted RA preambles, and determines whether a handover failure occurs according to a counting result.

For example, if the number of transmitted RA preambles exceeds a threshold (called a third threshold), it is considered that a handover failure occurs.

In the above embodiments, a value of the third threshold is not limited, and may be set as needed.

In some other embodiments, the terminal equipment determines whether a handover failure occurs based on the number of received ACKs/NACKs.

In the above embodiments, that the terminal equipment performs failure detection includes: the terminal equipment performs monitoring on NACK and/or ACK of a HARQ process carrying the first UL data, and determines whether a handover failure occurs according to a monitoring result.

For example, if Y consecutive NACK indications are received within a period of time, it is considered that a handover failure occurs, and/or, if an ACK indication is not received within a period of time (for example Y consecutive ACK indications are not received), it is considered that a handover failure occurs.

Each of the above embodiments only exemplarily describes how does a terminal equipment determine whether a handover failure occurs, but the present disclosure is not limited to this, appropriate modifications may be further made based on the above each embodiment. For example, each of the above embodiments may be used individually, or one or more of the above embodiments may be combined.

In the embodiments of the present disclosure, in some implementations, when a failure is detected, the terminal equipment may further apply configuration used before an RRC reconfiguration message including configuration of a candidate cell and/or a cell switch command is/are received.

For example, when a link failure or a handover failure is detected, the terminal equipment may apply configuration used before an RRC reconfiguration message including configuration of a candidate cell and/or a cell switch command is/are received.

The method in the embodiments of the present disclosure is exemplarily described below in conjunction with the drawings.

FIG. 5 is another schematic diagram of a failure detection and recovery method in the embodiments of the present disclosure. As shown in FIG. 5, the method includes:
501, a terminal equipment performs failure detection after receiving candidate configuration; and
502, when the terminal equipment detects a terminal equipment processing failure, the terminal equipment applies stored configuration and/or reports the failure to a network device via a secondary cell and/or a non-serving cell.

In the above example, the candidate configuration is e.g. an RRC reconfiguration message carrying candidate cell information.

In the above example, the method for performing failure detection and the method for reporting failure have been described in the preceding text, their contents are incorporated here, and are not repeated here.

FIG. 6 is a further schematic diagram of a failure detection and recovery method in the embodiments of the present disclosure. As shown in FIG. 6, the method includes:
601, a terminal equipment performs failure detection after transmitting a measurement report; and
602, when the terminal equipment detects a measurement reporting failure, the terminal equipment applies stored configuration and/or reports the failure to a network device via a secondary cell and/or a non-serving cell.

In the above example, the method for performing failure detection and the method for reporting failure have been described in the preceding text, their contents are incorporated here, and are not repeated here.

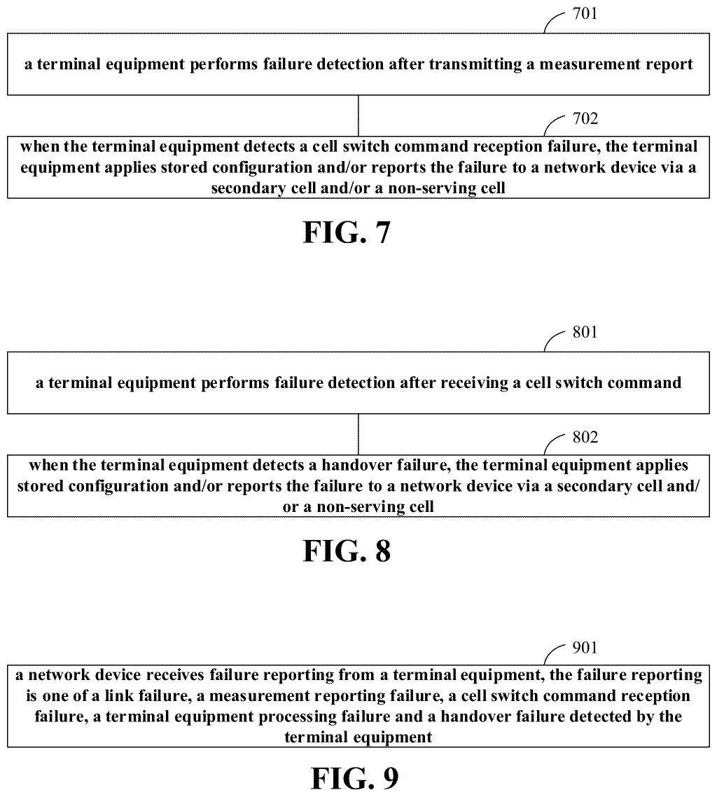

FIG. 7 is another schematic diagram of a failure detection and recovery method in the embodiments of the present disclosure. As shown in FIG. 7, the method includes:
701, a terminal equipment performs failure detection after transmitting a measurement report; and
702, when the terminal equipment detects a cell switch command reception failure, the terminal equipment applies stored configuration and/or reports the failure to a network device via a secondary cell and/or a non-serving cell.

In the above example, the method for performing failure detection and the method for reporting failure have been described in the preceding text, their contents are incorporated here, and are not repeated here.

FIG. 8 is a further schematic diagram of a failure detection and recovery method in the embodiments of the present disclosure. As shown in FIG. 8, the method includes:
801, a terminal equipment performs failure detection after receiving a cell switch command; and
802, when the terminal equipment detects a handover failure, the terminal equipment applies stored configuration and/or reports the failure to a network device via a secondary cell and/or a non-serving cell.

In the above example, the method for performing failure detection and the method for reporting failure have been described in the preceding text, their contents are incorporated here, and are not repeated here.

In the above example, optionally, if the terminal equipment applies configuration of a cell indicated by the cell switch command, the terminal equipment may apply configuration used before an RRC reconfiguration message including configuration of a candidate cell and/or a cell switch command is/are received.

It should be noted that the above FIG. 5 to FIG. 8 only schematically describe the embodiments of the present disclosure, but the present disclosure is not limited to this. For example, other some operations can be increased or operations therein may be reduced. Persons skilled in the art can make appropriate modifications according to the above contents, not limited to the records in the above FIG. 5 to FIG. 8.

Embodiments of the present disclosure further provides a failure detection and recovery method, which is described from a network side, and the contents same as the preceding text are not repeated.

FIG. 9 is a schematic diagram of a failure detection and recovery method in the embodiments of the present disclosure. As shown in FIG. 9, the method includes:
901, a network device receives failure reporting from a terminal equipment, the failure reporting is one of a link failure, a measurement reporting failure, a cell switch command reception failure, a terminal equipment processing failure and a handover failure detected by the terminal equipment.

In the above embodiment, the failure reporting may be reported by the terminal equipment via a secondary cell, or may be reported by the terminal equipment via a non-serving cell. Contents of failure detection and the non-serving cell have been described in detail in the preceding text, and are not repeated here.

In some embodiments, the network device may further configure thresholds for the terminal equipment, such as the first to third thresholds described above. The present disclosure does not limit specific configuration methods.

In some embodiments, the network device may further configure timers for the terminal equipment, such as the first to sixth timers described above. The present disclosure does not limit specific configuration methods.

According to the method in the embodiments of the present disclosure, when one of a link failure, a measurement reporting failure, a cell switch command reception failure, a terminal equipment processing failure and a handover failure is detected, a terminal applies stored configuration and/or reports the failure via a secondary cell/a non-serving cell, thereby failure detection and recovery may be performed faster, thus reducing service interruption time and improving user experience.

### Embodiments of a Second Aspect

Embodiments of the present disclosure provide a failure detection and recovery device. The device may, for example, be a terminal equipment, or may be one or more parts or components configured in the terminal equipment. The device in the embodiments of the present disclosure corresponds to the method in FIG. 4 of the embodiments of the first aspect, the contents same as those in the embodiments of the first aspect are not repeated.

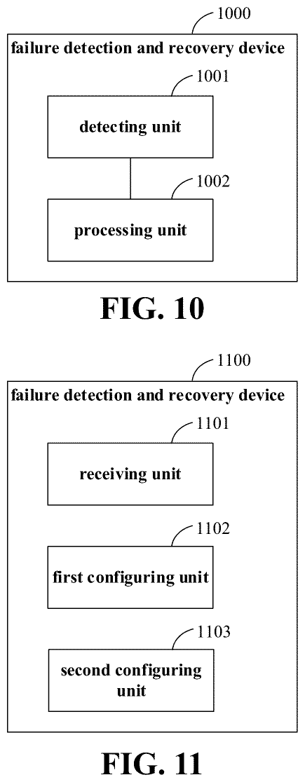

FIG. 10 is a schematic diagram of an example of a failure detection and recovery device in the embodiments of the present disclosure. As shown in FIG. 10, the failure detection and recovery device 1000 in the embodiments of the present disclosure includes:
a detecting unit 1001 configured to perform failure detection; and
a processing unit 1002 configured to, when one of a link failure, a measurement reporting failure, a cell switch command reception failure, a terminal equipment processing failure and a handover failure is detected, apply stored configuration for recovery and/or report the failure to a network device via a secondary cell and/or a non-serving cell.

In some embodiments, when the detecting unit 1001 detects one of a link failure, a measurement reporting failure, a cell switch command reception failure, a terminal equipment processing failure and a handover failure, the processing unit 1002 applies stored configuration for recovery; and if the processing unit 1002 cannot apply the stored configuration for recovery, the processing unit 1002 reports the failure to a network device via a secondary cell and/or a non-serving cell.

In some embodiments, that the processing unit 1002 reports the failure to a network device via a secondary cell and/or a non-serving cell includes: reporting the failure to a network device via a secondary cell; if the secondary cell is unavailable, reporting the failure to the network device via a non-serving cell.

In some embodiments, the stored configuration refers to configuration of a cell or cell group in an RRC reconfiguration message received and stored by the terminal equipment,
wherein the configuration of the cell or cell group may include configuration of a primary cell and/or configuration of a secondary cell and beam information; the beam information is TCI state information of a downlink channel or uplink channel or reference signal.

In some embodiments, if there are more than N of the TCI state information, the processing unit 1002 applies M pieces of the TCI state information indicated or default or determined through evaluation, in more than N pieces of the TCI state information, where M≤N, and N is 1 or 2, depending on a capability of the terminal equipment.

In some embodiments, the non-serving cell is a candidate cell for handover or a cell associated with a serving cell.

In some embodiments, that the processing unit 1002 reports the failure to a network device via a secondary cell and/or a non-serving cell includes reporting at least one of the following: cell information of a failed cell; a failure cause and/or a failure type; a measurement result; and expected processing.

In the above embodiments, the cell information of a failed cell may include at least one of the following: a cell index, a cell ID.

In the above embodiments, the failure cause may include at least one of the following: that a corresponding timer expires, the number of received NACKs reaches a maximum value, and the number of RAP transmissions reach a maximum number; and the failure type includes at least one of the following: a link failure, a measurement reporting failure, a cell switch command reception failure, a terminal equipment processing failure, and a handover failure.

In the above embodiments, the measurement result may include a L1 measurement or L3 measurement based measurement result of a beam and/or a cell for a failed cell and/or a candidate cell that meets a condition.

In the above embodiments, the expected processing may include at least one of the following: a beam switch, and a cell switch.

In some embodiments, the processing unit 1002 reports the failure via an RRC message or a MAC CE.

In some embodiments, when the quality of a radio link or the quality of a control channel is not good or poor, the detecting unit 1001 considers that a link failure occurs.

For example, the detecting unit 1001 (a physical layer of the terminal equipment) performs measurement on a configured reference signal, and provides indications of poor quality and/or good quality to a higher layer; the detecting unit 1001 (a higher layer of the terminal equipment) determines whether a link failure occurs according to received indications and/or a timer.

In the above example, the higher layer may be an MAC layer and/or an RRC layer.

In the above example, the reference signal may be one of the following: a configured reference signal used for beam failure detection (BFD-RS), a configured reference signal used for radio link monitoring (RLM-RS), a reference signal configured for fast or lower-layer radio link failure detection.

In the above example, the reference signal may be configured per serving cell.

In the above example, “the quality is poor and/or good” may refer to that: the L1 measurement result is worse and/or better than a configured first threshold; or the filtered L1 measurement result is worse and/or better than a configured second threshold.

In the above example, the L1 measurement result may include at least one of the following: L1 RSRP, including SS-RSRP or CSI-RSRP; L1 RSRQ, including SS-RSRQ or CSI-RSRQ; L1 SINR, including SS-SINR or CSI-SINR.

In the above example, the filtered L1 measurement result is a measurement result derived after the L1 measurement result is processed, for example, it may include: an average value of L1 measurement results within a period of time, or an average value of multiple highest L1 measurement results.

In some implementations, the detecting unit 1001 (a higher layer of the terminal equipment) starts or restarts a first timer upon receiving indications of poor quality; recounts the number of the indications of poor quality when the first timer expires; and considers that a link failure occurs upon receiving M consecutive indications of poor quality.

In some implementations, the detecting unit 1001 (a higher layer of the terminal equipment) starts a second timer upon receiving M consecutive indications of poor quality; the detecting unit 1001 (the higher layer of the terminal equipment) stops the second timer upon receiving T indications of good quality; and considers that a link failure occurs when the second timer expires.

In some implementations, when the detecting unit 1001 (the higher layer of the terminal equipment) receives M consecutive indications of poor quality while a third timer is running, it is considered that a link failure occurs.

In some implementations, when the detecting unit 1001 (the higher layer of the terminal equipment) receives M consecutive indications of poor quality, it is considered that a link failure occurs; when the detecting unit 1001 (the higher layer of the terminal equipment) receives T indications of good quality, the number of indications of poor quality is recounted.

In some implementations, when the detecting unit 1001 (the higher layer of the terminal equipment) receives M consecutive indications of poor quality, it is considered that a link failure occurs.

For another example, the detecting unit 1001 performs monitoring on NACK and/or ACK of a HARQ process; and determines whether a link failure occurs according to a monitoring result.

In some implementations, if S consecutive NACK indications are received within a period of time, it is considered that a link failure occurs, and/or, if an ACK indication is not received within a period of time, it is considered that a link failure occurs.

In the above example, the HARQ process may be a specified HARQ process, or one HARQ process, or all HARQ processes.

In some other embodiments, when L1 or L2 signaling carrying a measurement result is not successfully transmitted to a network, the detecting unit 1001 considers that a measurement reporting failure occurs.

For example, the detecting unit 1001 starts a fourth timer when the terminal equipment generates or delivers to a lower layer or transmits L1 or L2 signaling carrying a measurement result; when the fourth timer expires, it is considered that a measurement reporting failure occurs.

In the above example, when the terminal equipment receives ACK of the HARQ process of the L1 or L2 signaling carrying the measurement result, or receives an UL grant for scheduling new transmission of the HARQ process, or receives a cell switch command, the detecting unit 1001 stops the fourth timer.

For another example, the detecting unit 1001 performs monitoring on NACK and/or ACK of a HARQ process of the L1 or L2 signaling carrying the measurement result; and determines whether a measurement reporting failure occurs according to a monitoring result.

In some implementations, if X consecutive NACK indications are received within a period of time, it is considered that a measurement reporting failure occurs, and/or, if an ACK indication is not received within a period of time, it is considered that a measurement reporting failure occurs.

In some other embodiments, after L1 or L2 signaling carrying a measurement result is transmitted successfully, if no cell switch command is received within a period of time, the detecting unit 1001 considers that a cell switch command reception failure occurs.

For example, for the HARQ process of the L1 or L2 signaling carrying the measurement result, when the terminal equipment receives an ACK indication, the detecting unit 1001 starts a fifth timer; and considers that a cell switch command reception failure occurs when the fifth timer expires.

In the above example, when the terminal equipment receives a cell switch command, the detecting unit 1001 may stop the fifth timer.

In the above example, the cell switch command may be carried by DCI or MAC CE or RRC message.

In some other embodiments, when the terminal equipment is unable to comply with an RRC reconfiguration message that carries candidate cell information, or is unable to comply with PCell configuration in the RRC reconfiguration message that carries the candidate cell information, or is unable to comply with PCell indicated by an L1 or L2 cell switch command in the RRC reconfiguration message that carries the candidate cell information, the detecting unit 1001 considers that a terminal equipment processing failure occurs.

In the above embodiments, the PCell configuration includes configuration of L1 or L2 or L3; the configuration of L1 or L2 or L3 includes at least one of MAC configuration, radio bearer configuration, RF configuration.

In some other embodiments, when a L1 or L2 signaling based cell switch fails, the detecting unit 1001 considers that a handover failure occurs.

For example, when the terminal equipment receives L1 or L2 signaling used to trigger a cell switch, the detecting unit 1001 starts a sixth timer; and considers that a handover failure occurs when the sixth timer expires.

In the above example, when the terminal equipment completes a random access procedure, or the terminal equipment begins to communicate with an indicated cell, or the terminal equipment transmits, to a target cell, information for indicating that handover is completed or handover to the target cell is successful, the detecting unit 1001 stops the sixth timer.

For another example, the detecting unit 1001 counts the number of RA preambles transmitted by the terminal equipment, and determines whether a handover failure occurs according to a counting result.

In some implementations, if the number of RA preambles transmitted by the terminal equipment exceeds a third threshold, the detecting unit 1001 considers that a handover failure occurs.

For another example, the detecting unit 1001 performs monitoring on NACK and/or ACK of a HARQ process carrying a first UL data; and determines whether a handover failure occurs according to a monitoring result.

In the above example, in some implementations, if the terminal equipment receives Y consecutive NACK indications within a period of time, the detecting unit 1001 considers that a handover failure occurs, and/or, if the terminal equipment does not receive an ACK indication within a period of time, the detecting unit 1001 considers that a handover failure occurs.

In the embodiments of the present disclosure, optionally, in a case where a failure is detected, the processing unit 1002 may further apply configuration used before a terminal equipment receives an RRC reconfiguration message including configuration of a candidate cell and/or a cell switch command.

Embodiments of the present disclosure provide a failure detection and recovery device. The device may, for example, be a network device, or may be one or more parts or components configured in the network device. The device in the embodiments of the present disclosure corresponds to the method in FIG. 9 of the embodiments of the first aspect, the contents same as those in the embodiments of the first aspect are not repeated.

FIG. 11 is a schematic diagram of an example of a failure detection and recovery device in the embodiments of the present disclosure. As shown in FIG. 11, the failure detection and recovery device 1100 in the embodiments of the present disclosure includes:
a receiving unit 1101, configured to receive failure reporting from a terminal equipment, the failure reporting is one of a link failure, a measurement reporting failure, a cell switch command reception failure, a terminal equipment processing failure and a handover failure detected by the terminal equipment.

In the above embodiment, the failure reporting may be reported by the terminal equipment via a secondary cell, or may be reported by the terminal equipment via a non-serving cell. Contents of failure detection and the non-serving cell have been described in detail in the embodiments of the first aspect, and are not repeated here.

In some embodiments, as shown in FIG. 11, the device 1100 further includes:
a first configuring unit 1102, configured to configure thresholds for a terminal equipment, such as the first to third thresholds described in the embodiments of the first aspect. The present disclosure does not limit specific configuration methods.

In some embodiments, as shown in FIG. 11, the device 1100 further includes:
a second configuring unit 1103, configured to configure timers for a terminal equipment, such as the first to sixth timers described in the embodiments of the first aspect. The present disclosure does not limit specific configuration methods.

The above text is only illustrative for the embodiments of the present disclosure, but the present disclosure is not limited to this, appropriate modifications can be also made based on the above each embodiment. For example, each of the above embodiments may be used individually, or one or more of the above embodiments may be combined.

It's worth noting that the above only describes components or modules related to the present disclosure, but the present disclosure is not limited to this. The failure detection and recovery devices 1000 and 1100 in the embodiments of the present disclosure may further include other components or modules. For detailed contents of these components or modules, relevant technologies can be referred to. Moreover, the above components or modules may be realized by a hardware facility such as a processor, a memory, a transmitter, a receiver, etc. The embodiments of the present disclosure have no limitation to this.

According to the devices in the embodiments of the present disclosure, service interruption time is reduced, and user experience is improved.

### Embodiments of a Third Aspect

The embodiments of the present disclosure further provide a communication system, including a network device and a terminal equipment.

In some embodiments, the terminal equipment includes the device shown in FIG. 10 in the embodiments of the second aspect, configured to perform the method shown in FIG. 4 in the embodiments of the first aspect. Since each method has been described in details in the embodiments of the first aspect, its contents are incorporated here and are not repeated.

In the embodiments of the present disclosure, the terminal equipment includes the device shown in FIG. 11 in the embodiments of the second aspect, configured to perform the method shown in FIG. 9 in the embodiments of the first aspect. Since each method has been described in details in the embodiments of the first aspect, its contents are incorporated here and are not repeated. In addition, the network device performs normal operations of the network device, and the network device may further perform operations corresponding to the operations of the terminal equipment, for example the network device receives information/signals from the terminal equipment, and/or the network device transmits information/signals to the terminal equipment, descriptions are omitted here.

The embodiments of the present disclosure further provide a terminal equipment, the terminal equipment for example may be a UE, but the present disclosure is not limited to this, it may also be other terminal equipment.

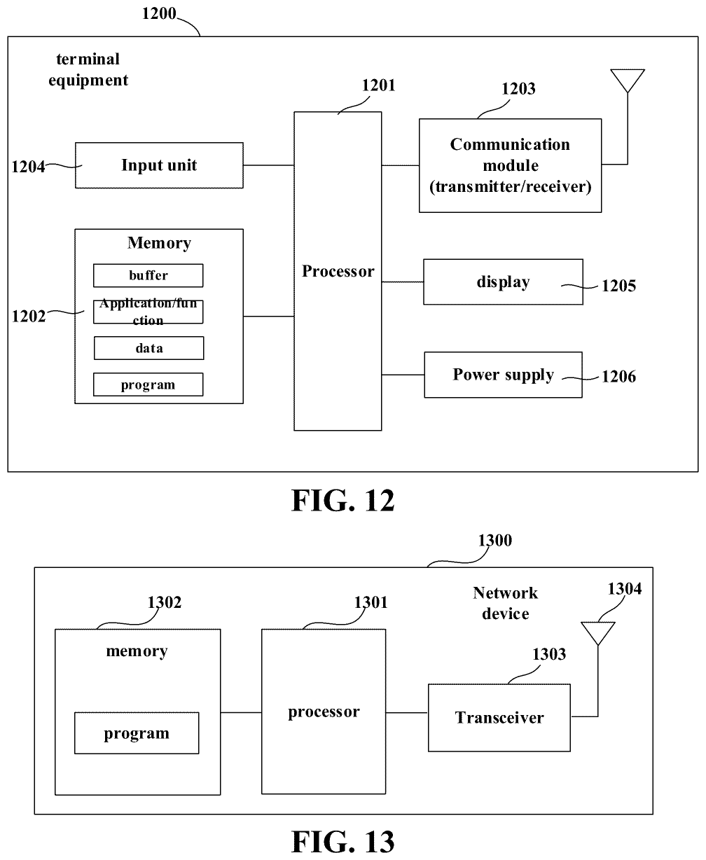

FIG. 12 is a schematic diagram of a terminal equipment in the embodiments of the present disclosure. As shown in FIG. 12, the terminal equipment 1200 may include a processor 1201 and a memory 1202; the memory 1202 stores data and programs, and is coupled to the processor 1201. It's worth noting that this figure is exemplary; other types of structures may also be used to supplement or replace this structure, so as to realize a telecommunication function or other functions.

In some embodiments, functions of the device in the embodiments of the second aspect may be integrated into the processor 1201, wherein the processor 1201 may be configured to execute a program to implement the method as described in the embodiments of the first aspect, the contents of which are incorporated herein and are not described repeatedly here.

In some other embodiments, the device in the embodiments of the second aspect may be configured separately from the processor 1201, for example the device in the embodiments of the second aspect may be configured as a chip connected to the processor 1201, functions of the device in the embodiments of the second aspect are realized through the control of the processor 1201.

As shown in FIG. 12, the terminal equipment 1200 may further include: a communication module 1203, an input unit 1204, a display 1205 and a power supply 1206. The functions of said components are similar to related arts, which are not repeated here. It's worth noting that the terminal equipment 1200 does not have to include all the components shown in FIG. 12, said components are not indispensable. Moreover, the terminal equipment 1200 may also include components not shown in FIG. 12, relevant technologies can be referred to.

The embodiments of the present disclosure further provide a network device, the network device for example may be a base station, but the present disclosure is not limited to this, it may also be other network device.

FIG. 13 is a composition schematic diagram of a network device in the embodiments of the present disclosure. As shown in FIG. 13, the network device 1300 may include: a processor 1301 and a memory 1302; the memory 1302 is coupled to the processor 1301. The memory 1302 may store various data; moreover, also stores a program for information processing, and executes the program under the control of the processor 1301.

In some embodiments, functions of the device 1100 in the embodiments of the second aspect may be integrated into the processor 1301, wherein the processor 1301 may be configured to execute a program to implement the method shown in FIG. 9 in the embodiments of the first aspect, the contents of which are incorporated herein and are not described repeatedly here.

In some other embodiments, the device 1100 in the embodiments of the second aspect may be configured separately from the processor 1301, for example the device 1100 in the embodiments of the second aspect may be configured as a chip connected to the processor 1301, functions of the device 1100 in the embodiments of the second aspect are realized through the control of the processor 1301.

In addition, as shown in FIG. 13, the network device 1300 may further include: transceivers 1303 and 1304. The functions of said components are similar to related arts, which are not repeated here. It's worth noting that the network device 1300 does not have to include all the components shown in FIG. 13. Moreover, the network device 1300 may also include components not shown in FIG. 13, relevant arts can be referred to.

The embodiments of the present disclosure further provide a computer program, wherein when a terminal equipment executes the program, the program enables the terminal equipment to execute the method described in the embodiments of the first aspect.

The embodiments of the present disclosure further provide a storage medium in which a computer program is stored, wherein the computer program enables a terminal equipment to execute the method described in the embodiments of the first aspect.

The device and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the principle of the present disclosure, these variations and modifications are also within the scope of the present disclosure.

As for the implementations including the above embodiments, the following supplements are further disclosed:
1. A failure detection and recovery method, including:
   a terminal equipment performs failure detection; and
   when the terminal equipment detects one of a link failure, a measurement reporting failure, a cell switch command reception failure, a terminal equipment processing failure and a handover failure, the terminal equipment applies stored configuration and/or reports the failure to a network device via a secondary cell and/or a non-serving cell.
2. The method according to Supplement 1, wherein
   when the terminal equipment detects one of a link failure, a measurement reporting failure, a cell switch command reception failure, a terminal equipment processing failure and a handover failure, the terminal equipment applies stored configuration; and
   if the stored configuration cannot be applied for recovery, the terminal equipment reports the failure to a network device via a secondary cell and/or a non-serving cell.
3. The method according to Supplement 1 or 2, wherein that the terminal equipment applies reports the failure to a network device via a secondary cell and/or a non-serving cell includes:
   the terminal equipment reports the failure to a network device via a secondary cell; and
   if the secondary cell is not available, the terminal equipment reports the failure to a network device via a non-serving cell.
4. The method according to Supplement 1, wherein
   the stored configuration is configuration of a cell or cell group in an RRC reconfiguration message received and stored by the terminal equipment.
5. The method according to Supplement 4, wherein
   the configuration of the cell or cell group comprises configuration of a primary cell and/or configuration of a secondary cell and beam information;
   the beam information being TCI state information of a downlink channel or an uplink channel or a reference signal.
6. The method according to Supplement 5, wherein
   if there are more than N of the TCI state information, the terminal equipment applies M pieces of the TCI state information indicated or default or determined through evaluation, in more than N pieces of the TCI state information, where M≤N, and N is 1 or 2, depending on a capability of the terminal equipment.
7. The method according to Supplement 1, wherein
   the non-serving cell is a candidate cell for handover or a cell associated with a serving cell.
8. The method according to Supplement 1 or 7, wherein that the terminal equipment reports the failure to a network device via a secondary cell and/or a non-serving cell includes reporting at least one of the following:
   cell information of a failed cell;
   a failure cause and/or a failure type;
   a measurement result; and
   expected processing.
9. The method according to Supplement 8, wherein
   the cell information of a failed cell includes at least one of the following: a cell index, a cell ID.
10. The method according to Supplement 8, wherein
   the failure cause includes at least one of the following: that a corresponding timer expires, the number of received NACKs reaches a maximum value, and the number of RAP transmissions reach a maximum number; and
   the failure type includes at least one of the following: a link failure, a measurement reporting failure, a cell switch command reception failure, a terminal equipment processing failure, and a handover failure.
11. The method according to Supplement 8, wherein
   the measurement result includes a L1 measurement or L3 measurement based measurement result of a beam and/or a cell for a failed cell and/or a candidate cell that meets a condition.
12. The method according to Supplement 8, wherein
   the expected processing comprises at least one of the following: a beam switch, and a cell switch.
13. The method according to any one of Supplements 1 and 7 to 12, wherein the terminal equipment reports the failure via an RRC message or a MAC CE.
14. The method according to Supplement 1, wherein
   when the quality of a radio link or the quality of a control channel is not good or poor, the terminal equipment determines that a link failure is detected.
15. The method according to Supplement 1 or 14, wherein that the terminal equipment performs failure detection includes:
   a physical layer of the terminal equipment performs measurement on a configured reference signal, and provides indications of poor quality and/or good quality to a higher layer of the terminal equipment; and
   the higher layer of the terminal equipment determines whether a link failure is detected according to the received indication and/or a timer.
16. The method according to Supplement 15, wherein
   the higher layer is a MAC layer and/or an RRC layer.
17. The method according to Supplement 15, wherein the reference signal is one of the following:
   a configured reference signal used for beam failure detection (BFD-RS);
   a configured reference signal used for radio link monitoring (RLM-RS); and
   a reference signal configured for fast or lower-layer radio link failure detection.
18. The method according to Supplement 17, wherein
   the reference signal is configured per serving cell.
19. The method according to Supplement 15, wherein poor quality and/or good quality refers to that
   an L1 measurement result is worse and/or better than a configured first threshold; or
   a filtered L1 measurement result is worse and/or better than a configured second threshold.
20. The method according to Supplement 19, wherein the L1 measurement result includes at least one of the following:
   L1 RSRP, including SS-RSRP or CSI-RSRP;
   L1 RSRQ, including SS-RSRQ or CSI-RSRQ; and
   L1 SINR, including SS-SINR or CSI-SINR.
21. The method according to Supplement 19, wherein
   the filtered L1 measurement result is a measurement result derived after the L1 measurement result is processed, including an average value of L1 measurement results within a period of time, or an average value of multiple highest L1 measurement results.
22. The method according to Supplement 15, wherein
   when the higher layer of the terminal equipment receives the indications of poor quality, a first timer is started or restarted, and when the first timer expires, the number of the indications of poor quality is recounted; and when M consecutive indications of poor quality are received, it is determined that a link failure is detected; or
   when the higher layer of the terminal equipment receives M consecutive indications of poor quality, a second timer is started; when the higher layer of the terminal equipment receives T indications of good quality, the second timer is stopped; and when the second timer expires, it is determined that a link failure is detected; or
   when the higher layer of the terminal equipment receives M consecutive indications of poor quality while a third timer is running, it is determined that a link failure is detected; or
   when the higher layer of the terminal equipment receives M consecutive indications of poor quality, it is determined that a link failure is detected; and when the higher layer of the terminal equipment receives T indications of good quality, the number of the indications of poor quality is recounted; or
   when the higher layer of the terminal equipment receives M consecutive indications of poor quality, it is determined that a link failure is detected.
23. The method according to Supplement 1 or 14, wherein that the terminal equipment performs failure detection includes:
   the terminal equipment performs monitoring on NACK and/or ACK of a HARQ process; and
   the terminal equipment determines whether a link failure is detected according to a monitoring result.
24. The method according to Supplement 23, wherein that the terminal equipment determines whether a link failure is detected according to a monitoring result includes:
   if S consecutive NACK indications are received within a period of time, it is determined that a link failure is detected; and/or,
   if no ACK indication is received within a period of time, it is determined that a link failure is detected.
25. The method according to Supplement 23 or 24, wherein
   the HARQ process is a specified HARQ process, or one HARQ process, or all HARQ processes.
26. The method according to Supplement 1, wherein
   when L1 or L2 signaling carrying a measurement result is not successfully transmitted to a network, the terminal equipment determines that the measurement reporting failure is detected.
27. The method according to Supplement 1 or 26, wherein that the terminal equipment performs failure detection includes:
   the terminal equipment starts a fourth timer when generating or delivering to a lower layer or transmits L1 or L2 signaling carrying a measurement result; and
   when the fourth timer expires, the terminal equipment determines that a measurement reporting failure is detected.
28. The method according to Supplement 27, wherein
   when ACK of the HARQ process of the L1 or L2 signaling carrying the measurement result is received, or an UL grant for scheduling new transmission of the HARQ process is received, or a cell switch command is received, the fourth timer is stopped.
29. The method according to Supplement 1 or 26, wherein that the terminal equipment performs failure detection includes:
   the terminal equipment performs monitoring on NACK and/or ACK of a HARQ process of the L1 or L2 signaling carrying the measurement result; and
   the terminal equipment determines whether a measurement reporting failure is detected according to a monitoring result.
30. The method according to Supplement 29, wherein that the terminal equipment determines whether a measurement reporting failure is detected according to a monitoring result includes:
   if X consecutive NACK indications are received within a period of time, it is determined that a measurement reporting failure is detected; and/or,
   if no ACK indication is received within a period of time, it is determined that a measurement reporting failure is detected.
31. The method according to Supplement 1, wherein
   after L1 or L2 signaling carrying a measurement result is successfully transmitted, if no cell switch command is received within a period of time, the terminal equipment determines that the cell switch command reception failure is detected.
32. The method according to Supplement 1 or 31, wherein that the terminal equipment performs failure detection includes:
   for the HARQ process of the L1 or L2 signaling carrying the measurement result, the terminal equipment starts a fifth timer when receiving an ACK indication; and
   when the fifth timer expires, the terminal equipment determines that the cell switch command reception failure is detected.
33. The method according to Supplement 32, wherein
   the fifth timer is stopped when a cell switch command is received.
34. The method according to Supplement 32, wherein
   the cell switch command is carried by DCI or MAC CE or RRC message.
35. The method according to Supplement 1, wherein
   when the terminal equipment is unable to comply with an RRC reconfiguration message that carries candidate cell information, or is unable to comply with PCell configuration in the RRC reconfiguration message that carries the candidate cell information, or is unable to comply with PCell indicated by an L1 or L2 cell switch command in the RRC reconfiguration message that carries the candidate cell information, the terminal equipment determines that a terminal equipment processing failure is detected.
36. The method according to Supplement 35, wherein
   the PCell configuration includes configuration of L1 or L2 or L3; and
   the configuration of L1 or L2 or L3 includes at least one of MAC configuration, radio bearer configuration, RF configuration.
37. The method according to Supplement 1, wherein
   when a L1 or L2 signaling based cell switch fails, the terminal equipment determines that a handover failure is detected.
38. The method according to Supplement 1 or 37, wherein that the terminal equipment performs failure detection includes:
   the terminal equipment starts a sixth timer when receiving L1 or L2 signaling for triggering a cell switch; and
   when the sixth timer expires, the terminal equipment determines that the handover failure is detected.
39. The method according to Supplement 38, wherein
   when the terminal equipment completes a random access procedure, or the terminal equipment begins to communicate with an indicated cell, or the terminal equipment transmits, to a target cell, information for indicating that handover is completed or handover to the target cell is successful, the terminal equipment stops the sixth timer.
40. The method according to Supplement 1 or 37, wherein that the terminal equipment performs failure detection includes:
   the terminal device counts the number of transmitted RA preambles; and
   the terminal equipment determines whether a handover failure is detected according to a counting result.
41. The method according to Supplement 40, wherein that the terminal equipment determines whether a handover failure is detected according to a counting result includes:
   if the number of the transmitted RA preambles exceeds a third threshold, it is determined that a handover failure is detected.
42. The method according to Supplement 1 or 37, wherein that the terminal equipment performs failure detection includes:
   the terminal equipment performs monitoring on NACK and/or ACK of a HARQ process carrying a first UL data; and
   the terminal equipment determines whether a handover failure is detected according to a monitoring result.
43. The method according to Supplement 42, wherein that the terminal equipment determines whether a handover failure is detected according to a monitoring result includes:
   if Y consecutive NACK indications are received within a period of time, it is determined that a handover failure is detected; and/or,
   if no ACK indication is received within a period of time, it is determined that a handover failure is detected.
44. The method according to any one of Supplements 1 to 43, wherein the method further includes:
   the terminal equipment applies configuration used before an RRC reconfiguration message comprising configuration of a candidate cell and/or the cell switch command is/are received.
45. A terminal equipment, comprising a memory and a processor, the memory storing a computer program, and the processor being configured to execute the computer program to implement the method according to any one of Supplements 1 to 44.
46. A communication system, comprising a network device and the terminal equipment according to Supplement 45.

1. A failure detection and recovery device, applied in a terminal equipment, the device comprising:
a receiver configured to receive a layer 2 signaling for triggering cell switch; and
processor circuitry configured for:
performing failure detection after the receiver receives the layer 2 signaling, and
applying stored configuration when a handover failure is detected, the stored configuration at least comprising configuration of a cell or cell group in a radio resource control reconfiguration message received and stored by the terminal equipment.

2. The device according to claim 1, wherein the performing failure detection comprises:
starting a timer when the receiver receives the layer 2 signaling, and
determining that the handover failure is detected when the timer expires.

3. The device according to claim 1, wherein the performing comprises:
counting the number of transmitted random access preambles, and
determining whether a handover failure is detected according to a counting result.

4. The device according to claim 3, wherein the determining comprises:
determining that the handover failure is detected if the number of the transmitted random access preambles exceeds a threshold.

5. The device according to claim 1, wherein the performing comprises:
controlling to monitor negative feedback and/or positive feedback of a hybrid automatic repeat request process carrying a first uplink data, and
determining whether the handover failure is detected according to a monitoring result.

6. The device according to claim 1, wherein,
the processor circuitry is further configured for applying configuration used before the radio resource control reconfiguration message comprising configuration of a candidate cell and/or the layer 2 signaling for triggering cell switch is received.

7. A failure detection and recovery device, applied in a terminal equipment, the device comprising:
processor circuitry configured for:
performing failure detection; and
when one of a link failure, a measurement reporting failure, a cell switch command reception failure and a terminal equipment processing failure is detected, applying stored configuration and/or reporting the failure to a network device via an SCell and/or a non-serving cell,
wherein, the performing failure detection comprises monitoring negative feedback and/or positive feedback of a hybrid automatic repeat request process and determining whether the link failure is detected according to a monitoring result.

8. The device according to claim 7, wherein,
the stored configuration is configuration of a cell or cell group in a radio resource control reconfiguration message received and stored by the terminal equipment.

9. The device according to claim 8, wherein,
the configuration of the cell or cell group comprises configuration of a primary cell and/or configuration of a secondary cell and beam information,
the beam information being transmission configuration indication state information of a downlink channel or an uplink channel or a reference signal.

10. The device according to claim 7, wherein,
the non-serving cell is a candidate cell for handover or a cell associated with a serving cell.

11. The device according to claim 7, wherein that reporting the failure comprises reporting at least one of the following:
cell information of a failed cell;
a failure cause and/or a failure type;
a measurement result; and
expected processing.

12. The device according to claim 11, wherein,
the failure cause comprises at least one of the following: a corresponding timer expires, the number of pieces of received negative feedback reaches a maximum value, and the number of random access preamble transmissions reach a maximum number;
and the failure type comprises at least one of the following: a link failure, a measurement reporting failure, a cell switch command reception failure, and a terminal equipment processing failure.

13. The device according to claim 11, wherein,
the expected processing comprises at least one of the following: a beam switch, and a cell switch.

14. The device according to claim 7, wherein the performing failure detection comprises:
performing measurement on a configured reference signal, at a physical layer of the terminal equipment, and providing indication(s) of poor quality and/or good quality to a higher layer of the terminal equipment; and
determining, at the higher layer of the terminal equipment, whether the link failure is detected according to the received indication and/or a timer.

15. The device according to claim 14, wherein the reference signal is one of the following:
a configured reference signal used for beam failure detection;
a configured reference signal used for radio link monitoring; and
a reference signal configured for fast or lower-layer radio link failure detection.

16. The device according to claim 14, wherein,
the processor circuitry is configured for starting or restarting a first timer when the higher layer of the terminal equipment receives the indications of poor quality, and recounting the number of the indications of poor quality when the first timer expires; and determining that the link failure is detected when the higher layer of the terminal equipment receives M consecutive indications of poor quality; or
the processor circuitry is configured for starting a second timer when the higher layer of the terminal equipment receives M consecutive indications of poor quality; stopping the second timer when the higher layer of the terminal equipment receives T indications of good quality; and determining that a link failure is detected when the second timer expires; or
the processor circuitry is configured for determining that a link failure is detected when the higher layer of the terminal equipment receives M consecutive indications of poor quality while a third timer is running; or
the processor circuitry is configured for determining that a link failure is detected when the higher layer of the terminal equipment receives M consecutive indications of poor quality; and recounting the number of the indications of poor quality when the higher layer of the terminal equipment receives T indications of good quality; or
the processor circuitry is configured for determining that a link failure is detected when the higher layer of the terminal equipment receives M consecutive indications of poor quality.

17. The device according to claim 7, wherein the determining whether the link failure is detected comprises:
determining that a link failure is detected if S consecutive negative feedback indications are received within a period of time; and/or,
determining that a link failure is detected if no positive feedback indication is received within a period of time.

18. The device according to claim 7, wherein,
when layer 1 or layer 2 signaling carrying a measurement result is not successfully transmitted to a network, the processor circuitry determines that the measurement reporting failure is detected, or
after layer 1 or layer 2 signaling carrying a measurement result is successfully transmitted, if no cell switch command is received within a period of time, the processor circuitry determines that the cell switch command reception failure is detected.

19. The device according to claim 7, wherein,
when the terminal equipment is unable to comply with a radio resource control reconfiguration message carrying candidate cell information, or is unable to comply with configuration of a primary cell in the radio resource control reconfiguration message carrying the candidate cell information, or is unable to comply with a primary cell indicated by a layer 1 or layer 2 cell switch command in the radio resource control reconfiguration message carrying the candidate cell information, the processor circuitry determines that a terminal equipment processing failure is detected.

20. The device according to claim 7, wherein,
the processor circuitry is configured for applying configuration used before a radio resource control reconfiguration message and/or a cell switch command is received, the radio resource control reconfiguration message comprising configuration of a candidate cell.
